(19) United States
(12) Patent Application Publication
(10) Pub. No.: US 2025/0308033 A1
(43) Pub. Date: Oct. 2, 2025

(54) MOTION VECTORS BASED ON REGIONS OF INTEREST

(71) Applicant: ADVANCED MICRO DEVICES, INC., Santa Clara, CA (US)

(72) Inventors: Colin Riley, Milton Keynes (GB); Krzysztof Jacek Kaminski, Gdynia (PL)

(21) Appl. No.: 18/616,792

(22) Filed: Mar. 26, 2024

(51) Int. Cl. G06T 7/20; G06T 7/13; G06T 7/40; G06T 7/90; G06V 10/25; G06V 10/60

(52) U.S. Cl. CPC G06T 7/20; G06T 7/13; G06T 7/40; G06T 7/90; G06V 10/25; G06V 10/60

(57) ABSTRACT

A processing system performs a pre-pass of an optical flow process's input images to determine, for each region (e.g., each block) of an image, an associated level of interest. The level of interest for a region indicates the expected likelihood that an increased number of motion vector computations for that region will result in a higher quality output of an image processing pipeline. Accordingly, the processing system adjusts the parameters of the optical flow process for each region according to the region's corresponding level of interest, so that the optical flow process increases the number of motion vector computations for regions associated with a higher level of interest of interest and reduces the number of motion vector computations for regions associated with a lower level of interest.

### BACKGROUND

Image processing and other applications sometimes rely on optical flow information, and in particular motion vectors, to identify movement of features between image frames. For example, some video compression processes employ motion vectors to assist in representing a sequence of image frames with a relatively small amount of data. However, generating the motion vectors is often computationally intensive. For example, some optical flow processes generate motion vectors via a computationally intensive process of identifying matching pixels, or sets of pixels, between input images. It is difficult to effectively implement these optical flow approaches without expensive or advanced computer hardware, or without consuming a high amount computing resources, such as power or compute cycles.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that sets the parameters of an optical flow process based on identifying regions of interest in an input image in accordance with some embodiments.

FIG. 2 is a block diagram of a graphics pipeline implemented by an accelerator unit of FIG. 1, in accordance with some embodiments.

FIG. 3 is a block diagram illustrating an example of the processing system of FIG. 1 employing a pre-pass of an image to identify regions of interest and setting parameters for an optical flow process in accordance with some embodiments.

FIG. 4 is a diagram illustrating an example of the processing system of FIG. 1 identifying a region of interest of an image based on a set of rasterized motion vectors in accordance with some embodiments.

FIG. 5 is a diagram illustrating another example of the processing system of FIG. 1 identifying a region of interest of an image based on a set of rasterized motion vectors in accordance with some embodiments.

FIG. 6 is a diagram illustrating an example of the processing system of FIG. 1 identifying regions of interest of an image based on identified visual characteristics of the regions in accordance with some embodiments.

FIG. 7 is a flow diagram illustrating a method for setting the parameters for an optical flow process based on identified regions of interest of an image in accordance with some embodiments.

### DETAILED DESCRIPTION

An optical flow process is a module (e.g., set of software instructions or circuitry) configured to receive multiple related input frames, and to output a series of motion vectors describing how objects or other features are moving between those input frames. The motion vectors are used for any of a number of image processing tasks, such as image compression or object tracking, in an image processing pipeline. The quality of the motion vectors generated by the optical flow process depends at least in part on the number of computations performed to generate the motion vectors. For example, in some cases the optical flow process generates the motion vectors by comparing pixels, or a combination of pixels, between different input images, and the quality of the output motion vector tends to increase as the number of comparisons performed by the optical flow process increases. Accordingly, computing high quality motion vectors is a computationally expensive task. Furthermore, calculating high quality motion vectors for all regions of a set of input frames does not, at least in some cases, improve the overall quality of image processing. For example, in some cases the input frames provided to the optical flow process have areas of the frames with very little movement or contain items for which the motion between frames has already been determined (e.g., by an executing application). Generating high-quality motion vectors for these areas of the frame does not improve the overall quality of the image processing (e.g., does not improve the image compression or object tracking), but consumes a large amount of processing resources.

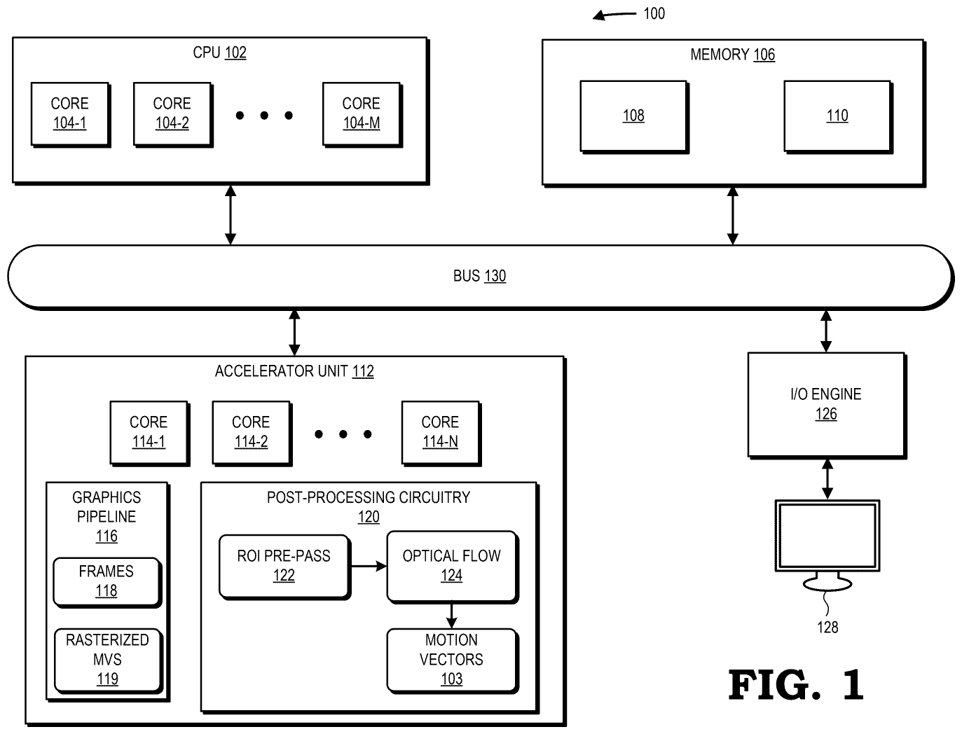

FIGS. 1-7 illustrate techniques for reducing the computation overhead associated with generating motion vectors. A processing system performs a pre-pass of the optical flow process's input images to determine, for each region (e.g., each block) of an image, an associated level of interest. The level of interest for a region indicates the expected likelihood that an increased number of motion vector computations for that region will result in a higher quality output of an image processing pipeline. Accordingly, the processing system adjusts the parameters of the optical flow process for each region according to the region's corresponding level of interest, so that the optical flow process increases the number of motion vector computations for regions associated with a higher level of interest of interest and reduces the number of motion vector computations for regions associated with a lower level of interest. The processing system thereby reduces the overall number of motion vector computations for an input image while maintaining a high quality of motion vectors for regions where higher quality motion vectors are likely to have the greatest impact on image processing.

To illustrate via an example, a given set of input images has a region of low interest, such as a region depicting an unchanging sky, and a region of high interest, such as a region depicting boats moving rapidly over water. Conventionally, an optical flow process calculates motion vectors for both the low interest region and the high interest region using the same parameters (e.g., based on the same search radius and the same number of search iterations), resulting same number of motion vector computations and the same quality of motion vectors for each region, and the. Furthermore, in order to ensure satisfactory image processing, the parameters of the optical flow process are set so that the generated motion vectors meet a specified level of quality for the high interest region. That is, the parameters are set so that the generated motion vectors are likely to sufficiently capture the movement of objects in the high interest region. However, because the low interest region has few, if any, moving objects, using the same parameters to generate motion vectors for the low interest region does not improve the overall quality of the image processing output. That is, motion vectors of relatively low quality are sufficient to identify movement of objects in the low interest region. Accordingly, using the techniques described herein, the parameters of the optical flow process are set for each region of an input image based on the level of interest identified for the region, so that the process calculates higher quality motion vectors for regions with a higher level of interest (that is, regions where higher quality motion vectors are expected to improve image processing output) and calculates lower quality motion for regions with a lower level of interest. The processing system thus maintains the overall quality of the image processing pipeline while reducing the overall number of calculations, and thus the amount of computer resources consumed by the generation of motion vectors.

The processing system identifies the level of interest for a region in any of a number of ways. For example, in some embodiments the processing system employs rasterized motion vectors to identify the level of interest for each region of an image. The rasterized motion vectors are generated by an application and indicate the expected movement of a designated geometry (e.g., object) between images. A rasterized motion vector (RMV) is thus able to be used for image processing when the images generated by an image processing pipeline reflect only the movement of the geometry. However, in some cases the image processing pipeline generates additional visual effects, such as shadows, transparencies, smoke effects, and the like, such that one or more of the RMVs are not suitable for use by the image processing pipeline. To determine whether an RMV is suitable for use, the processing system performs a pre-pass of an input image to determine if regions of an input image match the corresponding region of a previous image, wherein the corresponding regions are determined based on the RMV. Matching regions are indicated by the processing system as low interest regions, and thus omitted from (e.g., not provided to) the optical flow process, because the RMV is sufficient for performing image processing for the matching regions. Regions that have a mismatch are identified as high interest regions and are provided to the optical flow process for generation of motion vectors.

In other embodiments, the processing system determines the level of interest for a region of an image based on visual aspects of the region, such as one or more of the region color, texture, region edges (that is, any object edges identified in the region), region luma, and the like. The processing system performs a pre-pass of an input image to identify the visual aspects of the region, and based on the visual aspects assigns a level of interest value to the region. For example, in some embodiments the processing system assigns a relatively low interest value to a region having a solid color (that is, all the pixels of the region have the same color) and no edges and assigns a relatively high interest value to a region having different colors and one or more edges. Based on the interest value for a region, the processing system sets one or more parameters of the optical flow process, such as a motion vector search radius, search iterations, pixel resolution, and the like. For example, for a higher interest region, the processing system sets a larger search radius and a higher number of search iterations for the optical flow process, thereby increasing the quality of the motion vectors generated by the optical flow process for the region. In contrast, for a low interest region, the processing system sets a smaller search radius and a relatively low number of search iterations for the optical flow process, thereby reducing the quality of the generated motion vectors, and commensurately reducing the number of calculations required to generate the motion vectors. The processing system thus reduces the overall number of processing resources used to generate motion vectors for the input image while maintaining the quality of the motion vectors for the higher interest regions (that is, for the regions that are more likely to reflect movement of objects.

Referring now to FIG. 1, a processing system 100 configured to generate motion vectors based on regions of interest is presented, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 130 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), or any combination thereof. AU 112 is configured to generate a set of frames 118 each representing respective scenes within a screen space (e.g., the space in which a scene is displayed) according to one or more applications 110 for presentation on a display 128. As an example, AU 112 renders graphics objects (e.g., sets of primitives) for a scene to be displayed so as to produce pixel values representing a frame 118. AU 112 to post-processing circuitry 120 for further processing, such as compression, object tracking, and other image processing operations. In some cases, the post-processing circuitry provides the results of the processing of frame 118 (e.g., pixel values) to display 128. The pixel values of the frame 118, for example, include color values (YUV color values, RGB color values), depth values (z-values), or both.

After receiving a rendered frame, display 128 uses the pixel values of the rendered frame to display the scene including the rendered graphics objects. To render the graphics objects, AU 112 implements processor cores 114-1 to 114-N that execute instructions concurrently or in parallel. For example, AU 112 executes instructions, operations, or both from a graphics pipeline 116 using processor cores 114 to render one or more graphics objects. A graphics pipeline 116 includes, for example, one or more steps, stages, or instructions to be performed by AU 112 in order to render one or more graphics objects for a scene. As an example, example graphics pipeline 200 includes data indicating an input assembler stage, vertex shader stage, hull shader stage, tessellator stage, domain shader stage, geometry shader stage, rasterizer stage, pixel shader stage, output merger stage, or any combination thereof to be performed by one or more processor cores 114 of AU 112 in order to render one or more graphics objects for a scene to be displayed.

In embodiments, one or more processor cores 114 of AU 112 each operate as a compute unit configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each functioning as a compute unit that includes one or more SIMD units to perform operations for one or more instructions from a graphics pipeline 116. To facilitate the performance of operations by the compute units, AU 112 includes one or more command processors (not shown for clarity). Such command processors, for example, include circuitry configured to execute one or more instructions from a graphics pipeline 116 by providing data indicating one or more operations, operands, instructions, variables, register files, or any combination thereof to one or more compute units necessary for, helpful for, or aiding in the performance of one or more operations for the instructions. Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, AU 112 executes the instructions for the video tasks, physical simulation tasks, computational tasks, and fluid dynamics tasks. AU 112 then stores information in the memory 106 such as the results of the executed instructions.

To process the frames 118, in embodiments, AU 112 includes post-processing circuitry 120. Post-processing circuitry 120, for example, is configured to execute an optical flow process 124 to generate one or more motion vectors 103. A motion vector 103, for example, represents the movement of one or more graphics objects from a first frame (e.g., previous frame) and a second frame (e.g., current frame) of the frames 118. As an example, a motion vector 103 represents the movement of one or more pixels from a first position in a first frame to a second position in a second frame. To generate such motion vectors 103, the optical flow process 124 is configured to implement one or more motion estimation techniques, for example, block-matching processes, phase correlation methods, pixel recursive processes, optical flow methods, or any combination thereof, to name a few. For example, in some embodiments, the optical flow process 124 is configured to receive a set of pixels, referred to herein as a block, and to generate a motion vector for each block by performing the one or more motion estimation techniques based on the corresponding block of pixels. To illustrate, in some embodiments the input frame is divided by the post-processing circuitry 120 into a set of N×M pixel blocks, where N and M are integers. The optical flow process 124 is configured to receive at least a subset of the N×M pixel blocks and to generate a motion vector for each of the received pixel blocks.

As described further herein the optical flow methods implemented by the optical flow process 124 are configurable based on one or more optical flow parameters, such as a search radius (representing the radius of the search of a previous image to locate a matching set of pixels for a received block), a number of iterations (indicating the number of iterations of a corresponding matching process are to be executed for a block), pixel matching parameters (indicating, for example, how the pixels of a block are to be matched, such as whether individual pixels are to be matched or whether pixels are to be matched based on a combination (e.g. an average) of the pixels of the block), and the like. Furthermore, in some embodiments, the post processing circuitry 120 is configured to set the optical flow parameters individually for each block provided to the optical flow process. Thus, for example, in some cases the post processing circuitry sets the parameters for a first block of a frame to generate a relatively high-quality motion vector (e.g., by setting the parameters to have one or more of a large search radius, a high number of iterations, and to require matching of individual pixels) and sets the optical flow parameters for a second block of the frame to generate a lower quality motion vector (e.g. by setting the parameters to have one or more of a small search radius, a low number of iterations, and require an average of the pixels of the block to be matched).

To set the optical flow parameters for each block, the post-processing circuitry 120 includes a region of interest (ROI) pre-pass module 122. The ROI pre-pass module 122 is circuitry, a set of software instructions, or a combination thereof that is configured to analyze the blocks of an input image and identify an interest level for each block. Based on the identified interest level for a block, the ROI pre-pass module 122 sets the optical flow parameters for the block. For example, in response to identifying that the interest level for a block is a relatively high level, the ROI pre-pass module 122 sets the optical flow parameters to generate a higher quality motion vector 103. In response to identifying that the interest level for a block is relatively low level, the ROI pre-pass module 122 sets the optical flow parameters to generate a lower quality motion vector 103. The ROI pre-pass module thus lowers the number of calculations executed by the optical flow process 124 for blocks that are of lower interest (that is, for blocks that are not expected to include motion), thus conserving resources of the processing system 100 without reducing the overall quality of image processing. Furthermore, in some cases the ROI pre-pass module 122 determines that a given block is of sufficiently low interest that no motion vector is to be generated by the optical flow process 124. In response, in some embodiments the ROI pre-pass module 122 does not provide the block to the optical flow process 124. In other embodiments, the ROI pre-pass module 122 sets the parameters of the optical flow process 124 such that no motion vector is generated for the block (e.g., by setting a search radius or number of iterations to zero).

In some embodiments, to determine the interest level for a block, the ROI pre-pass module 122 employs rasterized motion vectors (rasterized MVs) 119, wherein the rasterized MVs 119 represent a set of motion vectors generated by an application to indicate the movement of geometry (e.g., objects) generated by the application. To illustrate, in some embodiments the CPU 102 executes an application 110, and the application 110 generates geometry (e.g., objects) and effects (e.g., shadows, smoke and fog effects, transparency effects, and the like) for rendering by the AU 112 at the frames 118. The application 110 is able to keep track of the movement of objects and other geometry, but not the movement or position of the effects, and instead relies on the AU 112 to determine the position of the effects for each generated frame 118. The application 110 generates the rasterized MVs 119 as motion vectors that indicate the movement of geometry between frames, but do not indicate the presence or movement of the effects, as those effects are implemented by the AU 112. Accordingly, the rasterized MVs 119 are suitable to perform image processing operations (e.g., compression and object tracking) for blocks wherein effects are not present. The ROI pre-pass module 122 is configured to determine, for each block of a frame, the corresponding block of the previous frame based on the rasterized MVs 119. For example, the rasterized MV 119 for a block indicates how that block has moved, in the X and Y directions, from the previous frame, and the ROI pre-pass module 122 thus identifies the corresponding block of the previous frame using the rasterized MV 119 for the block.

The ROI pre-pass module 122 compares the received block to the corresponding block of the previous frame. If the blocks match (that is, the pixel values of the blocks match within a specified threshold), there are no effects present in the block and the rasterized MV for the block is sufficient for image processing. Accordingly, in response to the blocks matching, the ROI pre-pass module 122 identifies the block as a low interest block. In some embodiments, this ensures that the optical flow process 124 does not generate a motion vector 103 for the block, and the AU 112 uses the rasterized MV 119 for the block for further image processing. If the blocks do not match, there may be effects present in the block. Accordingly, in response to identifying a mismatch between the blocks, the ROI pre-pass module 122 identifies the block as a high interest block and provides the block to the optical flow process 124. In response, the optical flow process 124 generates a motion vector 103 for the block, and the AU 112 uses the generated motion vector 103 for further image processing of the block.

In some embodiments, the ROI pre-pass module 122 identifies visual features of each block and determines a level of interest for a block based on the identified visual features of the block. Examples of the visual features identified by the ROI pre-pass module 122 in different embodiments include color (and differences in color within a block), texture, edges within the block, luma (and variations in luma within a block), and the like, or any combination thereof. In some embodiments, the ROI pre-pass module 122 assigns a higher level of interest for blocks having visual features that indicate a greater likelihood of block movement, and a lower level of interest for blocks having visual features that indicate a lower likelihood of block movement. For example, in some cases a block having only one color and no edges indicates that the block represents a background or unchanging portion of an image (e.g., a wall or sky). Accordingly, in response to determining that a block has only one color and no edges, the ROI pre-pass module 122 assigns a relatively low level of interest for the block. In response to determining that a block includes an edge and multiple colors, the ROI pre-pass module 122 assigns a relatively high level of interest for the block.

In some embodiments, processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the memory 106, AU 112, or the central processing unit (CPU) 102.

In embodiments, processing system 100 also includes CPU 102 that is connected to the bus 130 and therefore communicates with AU 112 and the memory 106 via the bus 130. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate graphics processing by issuing draw calls to AU 112.

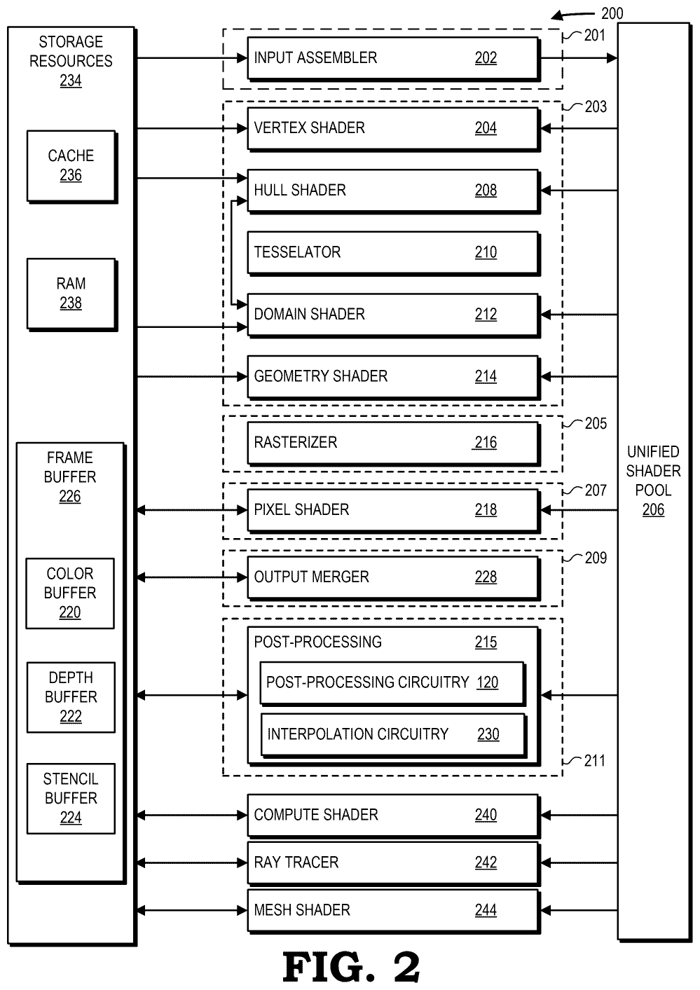

Referring now to FIG. 2, a block diagram of an example graphics pipeline 200 is presented, in accordance with some embodiments. In embodiments, example graphics pipeline 200 is implemented in processing system 100 as graphics pipeline 116. In embodiments, example graphics pipeline 200 is configured to render graphics objects as images that depict a scene which has three-dimensional geometry in virtual space (also referred to herein as “screen space”), but potentially a two-dimensional geometry. Example graphics pipeline 200 typically receives a representation of a three-dimensional scene, processes the representation, and outputs a two-dimensional raster image. These stages of example graphics pipeline 200 process data that is initially properties at end points (or vertices) of a geometric primitive, where the primitive provides information on an object being rendered. Typical primitives in three-dimensional graphics include triangles and lines, where the vertices of these geometric primitives provide information on, for example, x-y-z coordinates, texture, and reflectivity.

According to embodiments, example graphics pipeline 200 has access to storage resources 234 (also referred to herein as “storage components”). Storage resources 234 include, for example, a hierarchy of one or more memories or caches that are used to implement buffers and store vertex data, texture data, and the like, for example graphics pipeline 200. In some embodiments, storage resources 234 are implemented within processing system 100 using respective portions of system memory 106. In embodiments, storage resources 234 include or otherwise have access to one or more caches 236, one or more random access memory (RAM) units 238, video random access memory unit(s) (not pictured for clarity), one or more processor registers (not pictured for clarity), and the like, depending on the nature of data at the particular stage of example graphics pipeline 200. Accordingly, it is understood that storage resources 234 refer to any processor-accessible memory utilized in the implementation of example graphics pipeline 200.

Example graphics pipeline 200, for example, includes stages that each perform respective functionalities. For example, these stages represent subdivisions of functionality of example graphics pipeline 200. Each stage is implemented partially or fully as shader programs executed by AU 112. According to embodiments, stages 201 and 203 of example graphics pipeline 200 represent the front-end geometry processing portion of example graphics pipeline 200 prior to rasterization. Stages 203 to 211 represent the back-end pixel processing portion of example graphics pipeline 200.

During input assembler stage 201 of example graphics pipeline 200, an input assembler 202 is configured to access information from the storage resources 234 that is used to define objects that represent portions of a model of a scene. For example, in various embodiments, the input assembler 202 includes circuitry configured to read primitive data (e.g., points, lines and/or triangles) from user-filled buffers (e.g., buffers filled at the request of software executed by processing system 100, such as an application 110) and assembles the data into primitives that will be used by other pipeline stages of the example graphics pipeline 200. “User,” as used herein, refers to an application 110 or other entity that provides shader code and three-dimensional objects for rendering to example graphics pipeline 200. In embodiments, the input assembler 202 is configured to assemble vertices into several different primitive types (e.g., line lists, triangle strips, primitives with adjacency) based on the primitive data include in the user-filled buffers and formats the assembled primitives for use by the rest of example graphics pipeline 200.

According to embodiments, example graphics pipeline 200 operates on one or more virtual objects defined by a set of vertices set up in the screen space and having geometry that is defined with respect to coordinates in the scene. For example, the input data utilized in example graphics pipeline 200 includes a polygon mesh model of the scene geometry whose vertices correspond to the primitives processed in the rendering pipeline in accordance with aspects of the present disclosure, and the initial vertex geometry is set up in the storage resources 234 during an application stage implemented by, for example, CPU 102.

During the vertex processing stage 203 of example graphics pipeline 200, one or more vertex shaders 204 are configured to process vertexes of the primitives assembled by the input assembler 202. For example, a vertex shader 204 includes circuitry configured to first receive a single vertex of a primitive as an input and outputs a single vertex. The vertex shader 204 then performs various per-vertex operations such as transformations, skinning, morphing, per-vertex lighting, or any combination thereof, to name a few. Transformation operations include various operations to transform the coordinates (e.g., X-Y coordinate, Z-depth values) of the vertices. These operations include, for example, one or more modeling transformations, viewing transformations, projection transformations, perspective division, viewport transformations, or any combination thereof. Herein, such transformations are considered to modify the coordinates or “position” of the vertices on which the transforms are performed. Other operations of the vertex shader 204 modify attributes other than the coordinates.

In embodiments, one or more vertex shaders 204 are implemented partially or fully as vertex shader programs to be executed on one or more processor cores 114 (e.g., one or more processor cores 114 operating as compute units). Some embodiments of shaders such as the vertex shader 204 implement massive single-instruction-multiple-data (SIMD) processing so that multiple vertices are processed concurrently. In at least some embodiments, example graphics pipeline 200 implements a unified shader model so that all the shaders included in example graphics pipeline 200 have the same execution platform on the shared massive SIMD units of the processor cores 114. In such embodiments, the shaders, including one or more vertex shaders 204, are implemented using a common set of resources that is referred to herein as the unified shader pool 206.

During the vertex processing stage 203, in some embodiments, one or more vertex shaders 204 perform additional vertex processing computations that subdivide primitives and generate new vertices and new geometries in the screen space. These additional vertex processing computations, for example, are performed by one or more of a hull shader 208, a tessellator 210, a domain shader 212, and a geometry shader 214. The hull shader 208, for example, includes circuitry configured to operate on input high-order patches or control points that are used to define the input patches. Additionally, the hull shader 208 outputs tessellation factors and other patch data. According to embodiments, within example graphics pipeline 200, primitives generated by the hull shader 208 are provided to the tessellator 210. The tessellator 210 includes circuitry configured to receive objects (such as patches) from the hull shader 208 and generate information identifying primitives corresponding to the input object, for example, by tessellating the input objects based on tessellation factors provided to the tessellator 210 by the hull shader 208. Tessellation, as an example, subdivides input higher-order primitives such as patches into a set of lower-order output primitives that represent finer levels of detail (e.g., as indicated by tessellation factors that specify the granularity of the primitives produced by the tessellation process). As such, a model of a scene is represented by a smaller number of higher-order primitives (e.g., to save memory or bandwidth) and additional details are added by tessellating the higher-order primitive.

The domain shader 212 includes circuitry configured to receive a domain location, other patch data, or both as inputs. The domain shader 212 is configured to operate on the provided information and generate a single vertex for output based on the input domain location and other information. The geometry shader 214 includes circuitry configured to receive a primitive as an input and generate up to four primitives based on the input primitive. In some embodiments, the geometry shader 214 retrieves vertex data from storage resources 234 and generates new graphics primitives, such as lines and triangles, from the vertex data in storage resources 234. In particular, the geometry shader 214 retrieves vertex data for a primitive and generates one or more primitives. To this end, for example, the geometry shader 214 is configured to operate on a triangle primitive with three vertices. A variety of different types of operations can be performed by the geometry shader 214, including operations such as point sprint expansion, dynamic particle system operations, fur-fin generation, shadow volume generation, single pass render-to-cubemap, per-primitive material swapping, per-primitive material setup, or any combination thereof. According to embodiments, the hull shader 208, the domain shader 212, the geometry shader 214, or any combination thereof are implemented as shader programs to be executed on the processor cores 114, whereas the tessellator 210, for example, is implemented by fixed-function hardware.

Once front-end processing (e.g., stages 201, 203) of example graphics pipeline 200 is complete, the scene is defined by a set of vertices which each have a set of vertex parameter values stored in the storage resources 234. In certain implementations, the vertex parameter values output from the vertex processing stage 203 includes positions defined with different homogeneous coordinates for different zones.

As described above, stages 205 to 211 represent the back-end processing of example graphics pipeline 200. The rasterizer stage 205 includes a rasterizer 216 having circuitry configured to accept and rasterize simple primitives that are generated upstream. The rasterizer 216 is configured to perform shading operations and other operations such as clipping, perspective dividing, scissoring, viewport selection, and the like. In embodiments, the rasterizer 216 is configured to generate a set of pixels that are subsequently processed in the pixel processing/shader stage 207 of the example graphics processing pipeline. In some implementations, the set of pixels includes one or more tiles. In one or more embodiments, the rasterizer 216 is implemented by fixed-function hardware.

The pixel processing stage 207 of example graphics pipeline 200 includes one or more pixel shaders 218 that include circuitry configured to receive a pixel flow (e.g., the set of pixels generated by the rasterizer 216) as an input and output another pixel flow based on the input pixel flow. To this end, a pixel shader 218 is configured to calculate pixel values for screen pixels based on the primitives generated upstream and the results of rasterization. In embodiments, the pixel shader 218 is configured to apply textures from a texture memory, which, according to some embodiments, is implemented as part of the storage resources 234. The pixel values generated by one or more pixel shaders 218 include, for example, color values, depth values, and stencil values, and are stored in one or more corresponding buffers, for example, a color buffer 220, a depth buffer 222, and a stencil buffer 224, respectively. The combination of the color buffer 220, the depth buffer 222, the stencil buffer 224, or any combination thereof is referred to as a frame buffer 226. In some embodiments, example graphics pipeline 200 implements multiple frame buffers 226 including front buffers, back buffers and intermediate buffers such as render targets, frame buffer objects, and the like. Operations for the pixel shader 218 are performed by a shader program that executes on the processor cores 114.

According to embodiments, the pixel shader 218, or another shader, accesses shader data, such as texture data, stored in the storage resources 234. Such texture data defines textures which represent bitmap images used at various points in example graphics pipeline 200. For example, the pixel shader 218 is configured to apply textures to pixels to improve apparent rendering complexity (e.g., to provide a more “photorealistic” look) without increasing the number of vertices to be rendered. In another instance, the vertex shader 204 uses texture data to modify primitives to increase complexity, by, for example, creating or modifying vertices for improved aesthetics. AS an example, the vertex shader 204 uses a height map stored in storage resources 234 to modify displacement of vertices. This type of technique can be used, for example, to generate more realistic-looking water as compared with textures only being used in the pixel processing stage 207, by modifying the position and number of vertices used to render the water. The geometry shader 214, in some embodiments, also accesses texture data from the storage resources 234.

Within example graphics pipeline 200, the output merger stage 209 includes an output merger 228 accepting outputs from the pixel processing stage 207 and merges these outputs. As an example, in embodiments, output merger 228 includes circuitry configured to perform operations such as z-testing, alpha blending, stenciling, or any combination thereof on the pixel values of each pixel received from the pixel shader 218 to determine the final color for a screen pixel. For example, the output merger 228 combines various types of data (e.g., pixel values, depth values, stencil information) with the contents of the color buffer 220, depth buffer 222, and, in some embodiments, the stencil buffer 224 and stores the combined output back into the frame buffer 226. The output of the output merger stage 209 can be referred to as rendered pixels that collectively form a rendered frame 118. In one or more implementations, the output merger 228 is implemented by fixed-function hardware.

In embodiments, example graphics pipeline 200 includes a post-processing stage 211 implemented after the output merger stage 209. During the post-processing stage 211, post-processing circuitry 120 operates on the rendered frame stored (or individual pixels) stored in the frame buffer 226 to apply one or more post-processing effects, such as ambient occlusion or tonemapping, prior to the frame being output to the display. The post-processed frame is written to a frame buffer 226, such as a back buffer for display or an intermediate buffer for further post-processing. The example graphics pipeline 200, in some embodiments, includes other shaders or components, such as a computer shader 240, a ray tracer 242, a mesh shader 244, and the like, which are configured to communicate with one or more of the other components of example graphics pipeline 200.

In embodiments, to help improve the frame rate of a set of rendered frames 118 rendered by the example graphics pipeline 200, post-processing stage 215 includes interpolation circuitry 230. Interpolation circuitry 230, according to some embodiments, is implemented within or otherwise connected to post-processing circuitry 120. To generate an interpolated frame, post-processing circuitry 120 is configured to generate one or more motion vectors 103 based on two or more frames 118. For example, post-processing circuitry 120 first retrieves pixel data (e.g., color values, depth values) of a first frame (e.g., current frame) from respective color buffers 220 and depth buffers 222 associated with the first rendered frame. Further, post-processing circuitry 1200 retrieves pixel data of a second rendered frame (e.g., previous frame) from respective color buffers 220 and depth buffers 222 associated with the second rendered frame. In embodiments, the second rendered frame is the frame within a set of rendered frames 118 immediately preceding the first frame. post-processing circuitry 120 then implements one or more motion estimation techniques based on the pixel values associated with the first rendered frame and the pixel values associated with the second rendered frame to output one or more motion vectors 103. Based on one or of the determined motion vectors 103, interpolation circuitry 230 is configured to generate pixel values (e.g., color values, depth values, stencil values) for an interpolated frame that represents a scene temporally between, spatially between, or both the first rendered frame and the second rendered frame.

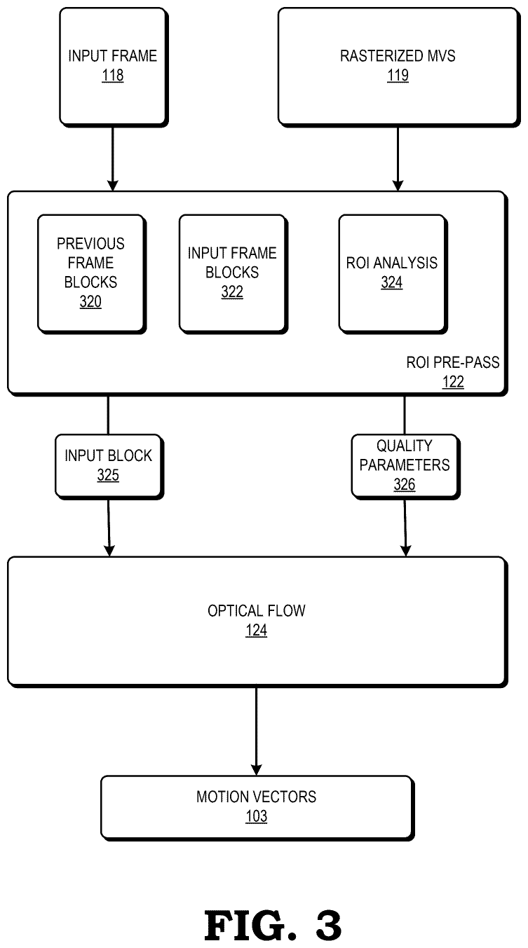

FIG. 3 illustrates an example of the post-processing circuitry 120 generating motion vectors for blocks of an input frame 118 based on levels of interest for each block in accordance with some embodiments. In the illustrated example, the ROI pre-pass module 122 receives the input frame 118 and separates the input frame 118 into a set of input frame blocks 322. For example, in some embodiments the ROI pre-pass module 122 generates the input frame blocks 322 by separating the input frame 118 into non-overlapping blocks of N×M pixels. In addition, the ROI pre-pass module 122 stores a set of previous frame blocks 320, representing the blocks of the previous frame (that is, the frame that the optical flow process is to use to generate motion vectors for the input frame 118).

The ROI pre-pass module 122 includes an ROI analysis module 324 that is circuitry, software instructions, or a combination thereof that is generally configured to analyze each of the input blocks 322 and, based on the analysis identify a level of interest to each of the input blocks 322. Based on the identified level of interest for a block, the ROI pre-pass module 122 determines a set of quality parameters 326 for the block. For example, in some embodiments the ROI pre-pass module 122 includes a programmable or configurable look-up table (LUT, not shown) that identifies for each level of interest, a corresponding set of quality parameters (e.g., search radius, number of iterations, pixel comparison criteria, and the like). In response to the ROI analysis module 324 identifying a level of interest for a block, the ROI pre-pass module 122 accesses the lookup table to determine, based on the identified level of interest, the quality parameters 326 for the block, and provides the block (as input block 325) and the quality parameters 326 to the optical flow process 124. Based on the input block 325 and the quality parameters 326, the optical flow process 124 employs one or more motion estimation techniques, for example, block-matching processes, phase correlation methods, pixel recursive processes, optical flow methods, or any combination thereof, to generate the motion vectors 103.

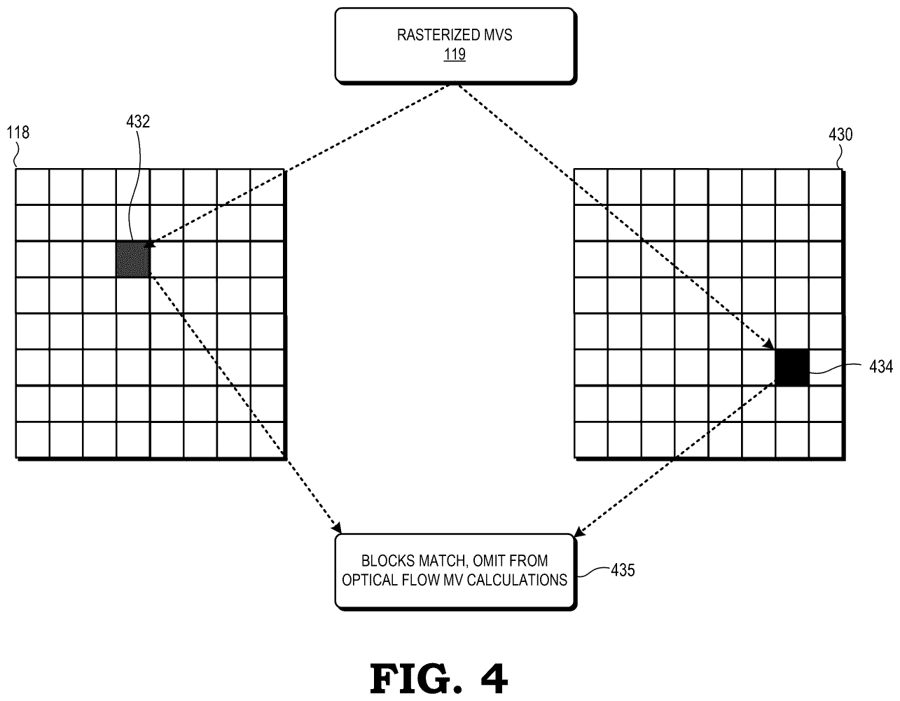

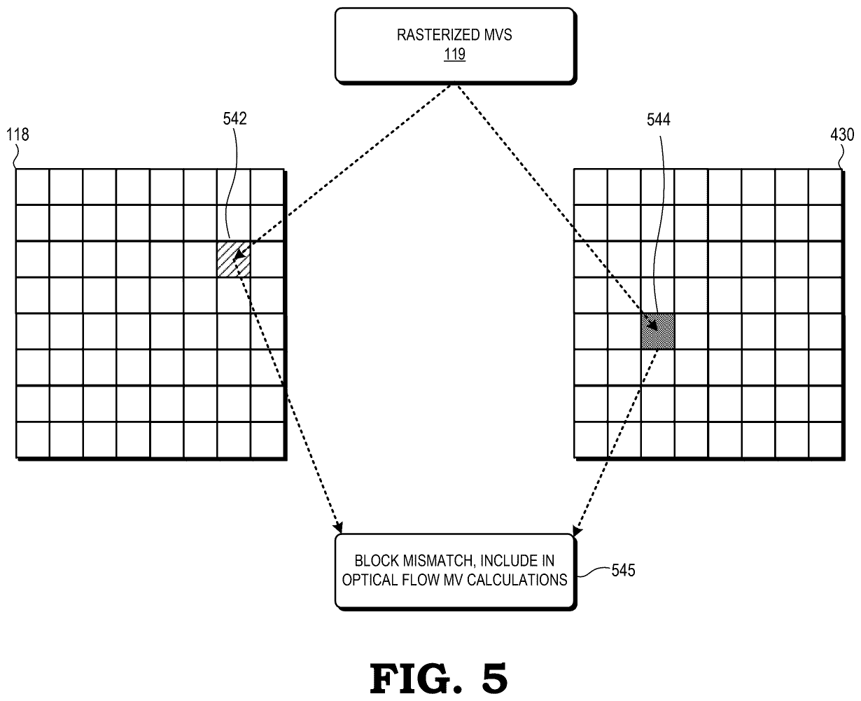

In some embodiments, to determine the level of interest for a block, the ROI analysis module 324 employs the rasterized MVs 119. Examples are illustrated at FIGS. 4 and 5 in accordance with some embodiments. FIG. 4 illustrates an example input frame 118 and an example previous frame 430. The ROI pre-pass module 122 has separated the input frame 118 into a plurality of input frame blocks 322, including a block 432. For each of the input frame blocks, the ROI analysis module 324 determines, based on the corresponding rasterized MV 119, the corresponding block of the previous frame 430. That is, the rasterized MV 119 for a block indicates the difference, in the X and Y directions, of the position of the block in the input frame 118 and the position of the corresponding block in the previous image 430. Accordingly, the ROI analysis module 324 uses the value of the rasterized MV 119 to perform a translation operation that indicates which block of the previous image 430 corresponds to a given block of the input frame 118.

In the example of FIG. 4, the ROI analysis module 324 determines, based on the rasterized MVs 119, that block 434 of the previous image 430 corresponds to block 432 of the input frame 118. The ROI analysis module 324 then compares the pixel values for the block 432 to the pixel values for the block 434. In the depicted example, it is assumed that the pixel values match within a specified threshold. This indicates that the rasterized MV for the block 432 is sufficient for further image processing operations, and a new motion vector from the optical flow process 124 is not needed. Accordingly, as indicated by box 435, the ROI analysis module 324 assigns a low interest level to the block 432, thus causing the block 432 to be effectively omitted from motion vector generation by the optical flow process 124.

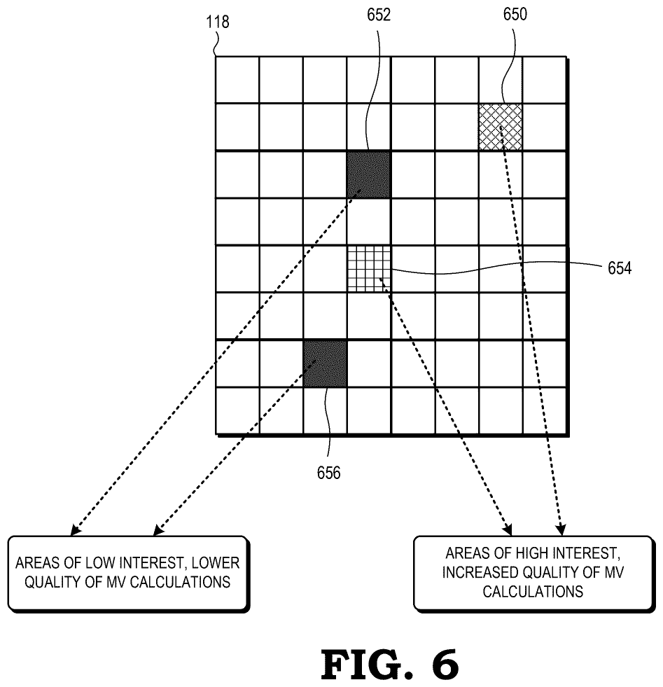

In the example of FIG. 5, the ROI analysis module 324 determines that block 542 of the input frame 118 corresponds to block 544 of the previous image 430. In response, the ROI analysis module 324 compares the pixel values of the blocks 542 and 544, and determines a block mismatch—that is, determines that the pixel values do not match within a specified threshold. This indicates the presence of effects at block 542, such that the rasterized MV for the block 542 is not sufficient for further image processing. Accordingly, as indicated by box 545, the ROI analysis module 324 assigns a high interest level to the block 542. In response to the assignment of the high interest level, the ROI pre-pass module 122 provides the block 542 and a corresponding set of quality parameters 326, to the optical flow process 124. In response, the optical flow process generates a motion vector for the block 542 based on the provided quality parameters. Thus, as illustrated by the examples of FIGS. 5 and 6, in some embodiments the ROI pre-pass module identifies which of the rasterized MVs 119 are suitable to be used for further image processing and omits the corresponding blocks from the optical flow process 124, thereby conserving resources at the processing system 100.

In some embodiments, the ROI analysis module 324 determines the level of interests for each of the input frame blocks 322 based on any visual features identified for the corresponding block. An example is illustrated at FIG. 6 in accordance with some embodiments. In the example of FIG. 6, it is assumed that the ROI analysis module 324 has analyzed each of the input frame blocks 322 (that is, the blocks of the input frame 118) and identified, for each block, one or more of the number of colors contained within the block, any edges contained within the block, any variations in luma within the block, any texture within the block (e.g., by performing a frequency analysis of the pixel values within the block), and the like. The ROI analysis module 324 has identified some of the input frame blocks 322, such as blocks 652 and 656, as having relatively few visual features of interest. For example, in some embodiments the ROI analysis module 324 has determined that the blocks 652 and 656 each have a single pixel color and do not include any edges. Accordingly, it is unlikely that generating high quality motion vectors for the blocks 652 and 656 will improve the quality of subsequent image processing. The ROI pre-pass module 122 therefore identifies the blocks 652 and 656 as being of relatively low interest and sets the motion vector quality parameters for the blocks 652 and 656 to relatively low quality. This ensures that the optical flow process 124 executes relatively few operations to generate the motion vectors for the blocks 652 and 656, thereby conserving resources (e.g., power) of the processing system 100.

In addition, in the example of FIG. 6, the ROI analysis module 324 has identified some of the input frame blocks 322, such as blocks 650 and 654, as having a relatively high number of visual features of interest. For example, in some embodiments the ROI analysis module 324 has determined that the blocks 650 and 654 each have different pixel colors within the block, include one or more edges, have variations in luma within the block, and the like. Accordingly, it is likely that generating high quality motion vectors for the blocks 650 and 654 will improve the quality of subsequent image processing. The ROI pre-pass module 122 therefore identifies the blocks 650 and 654 as being of relatively high interest and sets the motion vector quality parameters for the blocks 650 and 654 to relatively high quality. This ensures that the optical flow process 124 executes a relatively high number of operations to generate the motion vectors for the blocks 652 and 656, thereby ensuring the quality of the motion vectors for these blocks.

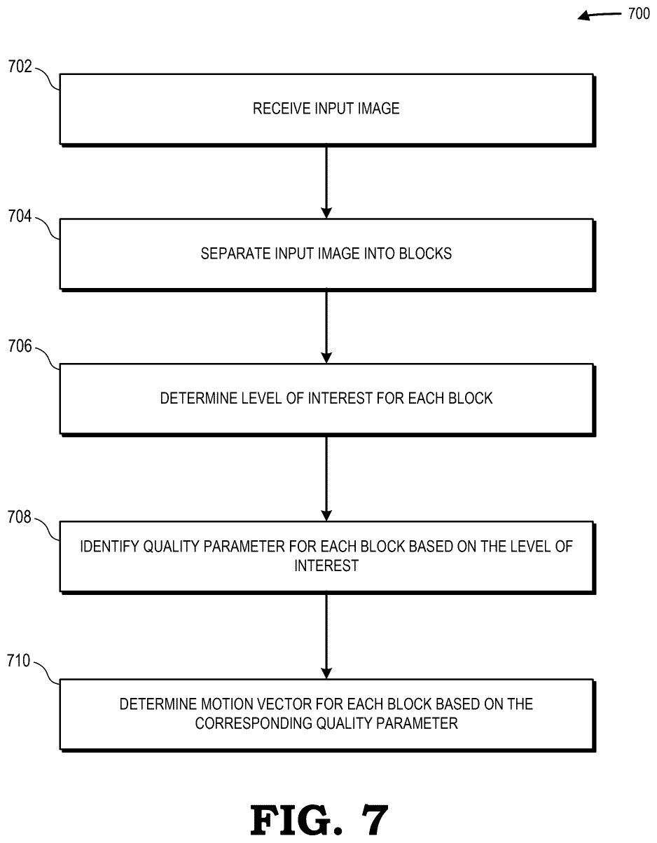

FIG. 7 illustrates a flow diagram of a method 700 of generating motion vectors for an image based on different levels of interest for different blocks of the image in accordance with some embodiments. For purposes of description, the method 700 is described with respect to an example implementation at the processing system 100 of FIG. 1, but it will be appreciated that in other embodiments the method 700 is implemented at processing systems having different configurations.

At block 702, the ROI pre-pass module 122 receives an input image, such as a frame 118. In at least some embodiments, the input image is a frame generated based on commands generated by an application 110, and the input image has been designated by the application 110 for further image processing, such as compression, object tracking, and the like, for which the motion vectors 103 are to be generated. At block 704, the ROI pre-pass module 122 separates the input image into a set of blocks, such as input frame blocks 322. For example, in some embodiments the ROI pre-pass module 122 generates the input frame blocks 322 by separating the input frame 118 into non-overlapping blocks of N×M pixels, where N and M are integers.

At block 706 the ROI pre-pass module 122 determines a level of interest for each block. In some embodiments, to determine the interest level for a block, the ROI pre-pass module 122 employs rasterized MVs that represent a set of motion vectors generated by an application to indicate the movement of geometry (e.g., objects) generated by the application. The ROI pre-pass module 122 is configured to determine, for each block of a frame, the corresponding block of the previous frame based on the rasterized MVs 119. For example, the rasterized MV 119 for a block indicates how that block has moved, in the X and Y directions, from the previous frame, and the ROI pre-pass module 122 thus identifies the corresponding block of the previous frame using the rasterized MV 119 for the block. The ROI pre-pass module 122 compares the received block to the corresponding block of the previous frame. If the blocks match (that is, the pixel values of the blocks match within a specified threshold), the ROI pre-pass module 122 determines that the rasterized MV for the block is sufficient for image processing and therefore identifies the block as a low interest block. In response to identifying a mismatch between the blocks, the ROI pre-pass module 122 identifies the block as a high interest block.

In some embodiments, the ROI pre-pass module 122 identifies visual features of each block and determines a level of interest for a block based on the identified visual features of the block. Examples of the visual features identified by the ROI pre-pass module 122 in different embodiments include color (and differences in color within a block), texture, edges within the block, luma (and variations in luma within a block), and the like, or any combination thereof. In some embodiments, the ROI pre-pass module 122 assigns a higher level of interest for blocks having visual features that indicate a greater likelihood of block movement, and a lower level of interest for blocks having visual features that indicate a lower likelihood of block movement.

At block 708, the ROI pre-pass module 122 identifies (e.g., based on a look-up table) a set of quality parameters for each block based on the corresponding level of interest. For example, in some embodiments the ROI pre-pass module 122 assigns higher quality parameters (that is, optical flow parameters that are expected to generate a higher quality motion vector) to blocks with a higher level of interest, and assigns lower quality parameters (that is, optical flow parameters that are expected to generate a higher quality motion vector) to blocks with a lower level of interest. At block 710 the optical flow process generates motion vectors 103 for one or more of the blocks using, for a given block, the quality parameters for the given block as identified by the ROI pre-pass module 122 at block 708.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
setting a motion vector quality parameter based on an identified first level of interest for a first region of an image; and
generating a first motion vector based on the motion vector quality parameter.

2. The method of claim 1, further comprising:
identifying the first level of interest for the first region based on a first rasterized motion vector for the image.

3. The method of claim 2, further comprising:
identifying a set of pixels of a reference image based on the first rasterized motion vector; and
identifying the first level of interest comprises comparing a set of pixels of the first region to the identified set of pixels of the reference image.

4. The method of claim 3, wherein identifying the first level of interest comprises identifying a low level of interest in response to the set of pixels of the first region matching the identified set of pixels of the reference image.

5. The method of claim 4, wherein setting the motion vector quality parameter comprises:
in response to identifying the low level of interest, omitting the first region from generation of the first motion vector.

6. The method of claim 1, further comprising:
identifying the first level of interest based on one or more identified visual aspects of the first region.

7. The method of claim 6, wherein the one or more visual aspects includes at least one of a color associated with the first region, an edge associated with the first region, a luma associated with the first region, and a texture associated with the first region.

8. The method of claim 1, wherein the motion vector quality parameter includes one or more of a search radius and a number of process iterations of an optical flow process.

9. The method of claim 1, further comprising:
setting the motion vector quality parameter to a higher quality for a second region of the image in response to determining the second region of the image has a higher level of interest than the first region of the image.

10. A method, comprising:
pre-processing an image to identify, for each of a plurality of regions of the image, a corresponding plurality of interest levels; and
setting quality levels for an optical flow process for each of the plurality of regions based on the corresponding plurality of interest levels.

11. The method of claim 10, wherein pre-processing the image comprises one or more of:
determining a match between each of the plurality of regions and corresponding regions of a reference image, the corresponding regions based on a set of rasterized motion vectors; and
identifying visual aspects of each of the plurality of regions.

12. A processing system comprising:
a processor including one or more processor cores configured to:
set a motion vector quality parameter based on an identified first level of interest for a first region of an image; and
generate a first motion vector based on the motion vector quality parameter.

13. The processing system of claim 12, wherein the one or more processor cores are configured to:
identify the first level of interest for the first region based on a first rasterized motion vector for the image.

14. The processing system of claim 13, wherein the one or more processor cores are configured to:
identifying a set of pixels of a reference image based on the first rasterized motion vector; and
identifying the first level of interest comprises comparing a set of pixels of the first region to the identified set of pixels of the reference image.

15. The processing system of claim 14, wherein the one or more processor cores are configured to identify the first level of interest by identifying a low level of interest in response to the set of pixels of the first region matching the identified set of pixels of the reference image.

16. The processing system of claim 15, wherein the one or more processor cores are configured to set the motion vector quality parameter by:
in response to identifying the low level of interest, omitting the first region from the generation of the first motion vector.

17. The processing system of claim 12, wherein the one or more processor cores are configured to:
identify the first level of interest based on one or more identified visual aspects of the first region.

18. The processing system of claim 17, wherein the one or more visual aspects includes at least one of a color associated with the first region, an edge associated with the first region, a luma associated with the first region, and a texture associated with the first region.

19. The processing system of claim 12, wherein the motion vector quality parameter includes one or more of a search radius and a number of process iterations of an optical flow process.

20. The processing system of claim 12, wherein the one or more processor cores are configured to:
set the motion vector quality parameter to a higher quality for a second region of the image in response to determining the second region of the image has a higher level of interest than the first region of the image.
